(19) United States
(12) Patent Application Publication
(10) Pub. No.: US 2025/0208944 A1
(43) Pub. Date: Jun. 26, 2025

(54) TEMPERATURE-EFFICIENCY CORRELATOR FOR FAULT PREVENTION WITH PRESCRIPTIVE SIGNALING SYSTEM

(71) Applicant: Datalogic IP Tech S.r.l., Calderara Di Reno (IT)

(72) Inventor: Francesco Pugliese, Bologna (IT)

(21) Appl. No.: 18/393,539

(22) Filed: Dec. 21, 2023

(51) Int. Cl. G06F 11/07

(52) U.S. Cl. CPC G06F 11/0793; G06F 11/0736; G06F 11/0754; G06F 11/0772

(57) ABSTRACT

Systems and methods for performing fault prevention and/or detection of electrical components using a temperature-efficiency correlator are provided. A system may include an input power sensor, output power sensor, and temperature sensor configured to sense measurements from electrical component(s) over time. The system may include processor(s) in communication with the sensors and be configured to calculate time-based measurement(s) as a function of the sensed input electrical power, output electrical power, and temperature of the electrical component(s). The processor(s) may be configured to determine, based on the time-based measurement(s), behavior from amongst multiple possible behaviors that the electrical component(s) may be exhibiting over the time period. Responsive to determining behavior, the processor(s) may be configured to generate a notification signal to be presented to the user that notifies the user to perform a prescriptive action to correct a potential or actual fault of the electrical component(s).

### BACKGROUND

Electronic devices (e.g., barcode readers, industrial scanners, imaging systems, computers, drones, vehicles, and other systems) include printed circuit boards (PCBs) and electrical components. Some systems include multiple components, such as a handheld barcode reader and charger therefor, where each include electrical power converters. Because these electrical components are typically contained inside a housing of a larger electronic device or system, it can be difficult for a user to determine whether one or more electrical components are experiencing a fault (e.g., overheating). Furthermore, even if a user detects a potential or actual fault, the user may not know the cause of the fault, the specific electronic component that is faulty, or the proper action to take to correct the potential or actual fault. As such, there is a need to predict or detect a potential or actual fault of electrical component(s) of an electronic device and to provide notice to a user or technician of a predicted potential or detected actual fault.

### BRIEF SUMMARY

To overcome the shortcomings of not being able to detect actual or predict potential faults of electrical components operating in a system, the principles described herein enable measurement of (i) electrical power into, (ii) electrical power out of, and (iii) temperature of electrical component(s) using sensors so as to calculate electrical system/component thermal resistance to enable predicting a potential fault or actual fault of one or more electrical components.

A temperature-efficiency correlator may be used for fault prevention and/or detection of electrical components. In particular, one embodiment relates to a computer-implemented method of notifying a user of a potential or actual fault of at least one electrical component. This process may include sensing (i) input electrical power component(s), (ii) sensing output electrical power from the electrical component(s), and (iii) sensing temperature of the electrical component(s) over a time period. At least one time-based measurement may be calculated as a function of the sensed input electrical power, output electrical power, and temperature of the electrical component(s) over the time period. A determination, based on the time-based measurement, may be made of behavior from amongst multiple possible behaviors that the electrical component(s) are exhibiting over the time period. In response to determining the behavior of the electrical component(s) over the time period, a notification signal may be generated and presented to the user that notifies the user to perform a prescriptive action to correct the potential or actual fault of the electrical component(s).

Another embodiment relates to a system including at least one input power sensor configured to sense input electrical power to at least one electrical component over a time period, at least one output power sensor configured to sense output electrical power from the electrical component(s) over the time period, and at least one temperature sensor configured to sense temperature from the electrical component(s) over the time period. The system further includes at least one processor configured to receive communications signals from the sensors. The processor(s) may be configured to calculate at least one time-based measurement as a function of the sensed input electrical power, output electrical power, and temperature of the electrical component(s) over the time period. The processor(s) may be configured to determine, based on the at least one-time based measurement, behavior from amongst multiple possible behaviors that the electrical component(s) may be exhibiting over the time period. In response to determining the behavior of the electrical component(s) over the time period, the processor(s) may further be configured to generate a notification signal to be presented to the user that notifies the user to perform a prescriptive action to correct a potential or actual fault of the electrical component(s) based on the determined behavior.

### BRIEF DESCRIPTION OF THE FIGURES

Illustrative embodiments of the present invention are described in detail below with reference to the attached drawing figures, which are incorporated by reference herein and wherein:

FIGS. 1A and 1B are illustrations of an illustrative handheld barcode reader with a number of electrical components while the handheld barcode reader is (i) connected to a docking/recharging station and (ii) positioned in an upright position that is independent of the docking station;

FIG. 2 is an illustration of an illustrative unmanned arial vehicle (UAV) (e.g., drone) with a number of electrical components;

FIGS. 3A and 3B are (i) a block diagram of an electrical circuit and (ii) an illustration of an illustrative printed circuit board (PCB) with a power converter and a number of electrical components;

FIGS. 4A and 4B are illustrations of illustrative temperature plots used to describe thermal resistance and impedance calculations in predicting or detecting potential or actual faults of one or more electrical components;

FIGS. 5A and 5B are block diagrams of (i) an illustrative electrical system or component describing input power, output power, and power losses, and (ii) an illustrative electrical component with an input power sensor and an output power sensor;

FIG. 6 is an illustration of an illustrative thermal resistance plot for an electrical system or component over a range of temperatures and conditions;

FIGS. 7A, 7B, and 7C are block diagrams showing various illustrative configurations of input power sensors, output power sensors, and temperature sensors used to determine the thermal resistance of (i) an electrical system (e.g., PCB), (ii) an electrical component, and (iii) multiple electrical components so as to detect a potential and/or actual fault of one or more electrical components;

FIGS. 8A, 8B, and 8C are illustrations of illustrative plots for an electrical system or component showing different behavior scenarios based on thermal resistance of the electrical system or component over time;

FIG. 9 is an illustration of an illustrative lookup table containing possible thermal resistance behavior, possible corresponding diagnoses, possible corresponding prescriptive actions, and representative signals corresponding to the signals in FIG. 8A; and

FIG. 10 is a block diagram of an illustrative computer-implemented process for notifying a user of a potential or actual fault of at least one electrical component.

### DETAILED DESCRIPTION

Thermal resistance describes the temperature variation of a component or system when the component or system dissipates a certain amount of electrical power, and the value of the thermal resistance can be determined by measuring the temperature and power loss associated with the component or system. Because the minimum thermal resistance of one or more electrical components or the electronic device can be expressed as a fixed value, a departure from the thermal resistance value may indicate a potential or actual electrical fault. The change in thermal resistance of a component or system can be measured over time and may correspond with one or more pre-defined behaviors associated with a particular type of electrical fault (e.g., bad thermal flow). Based on the behavior observed, a determination of the particular fault may be made, and a user may be instructed to perform a specific prescriptive action (or local action) to correct the potential or actual fault (e.g., visual inspection and cleaning of component). Such a determination of the potential or actual fault may be made automatically and a notification (e.g., illumination signal or data message) may be generated.

Electrical systems have the propensity for failure that is seldom convenient. The principles described herein may be used to provide advanced warnings to operators and technicians related to the potential or actual failure of an electrical system or component(s). This notification may include (i) providing users with information on the performance of an electrical system or component; (ii) suggesting corrective actions to users to improve the performance of an electrical system/component; (iii) maintaining high electrical system/component efficiency by allowing users to take corrective actions to correct potential or actual faults; (iv) reducing the need for maintenance of an electrical system/component and reducing the amount of electrical energy needed from external sources to power the electrical system/component; (v) providing detailed information in the case of failure of one or more electrical component(s) (e.g., fan, light-emitting diode) by recording the failure location, notifying a technician of the failure, and keeping a record of past failures to improve system design; and (vi) improving and generating analytics related to products.

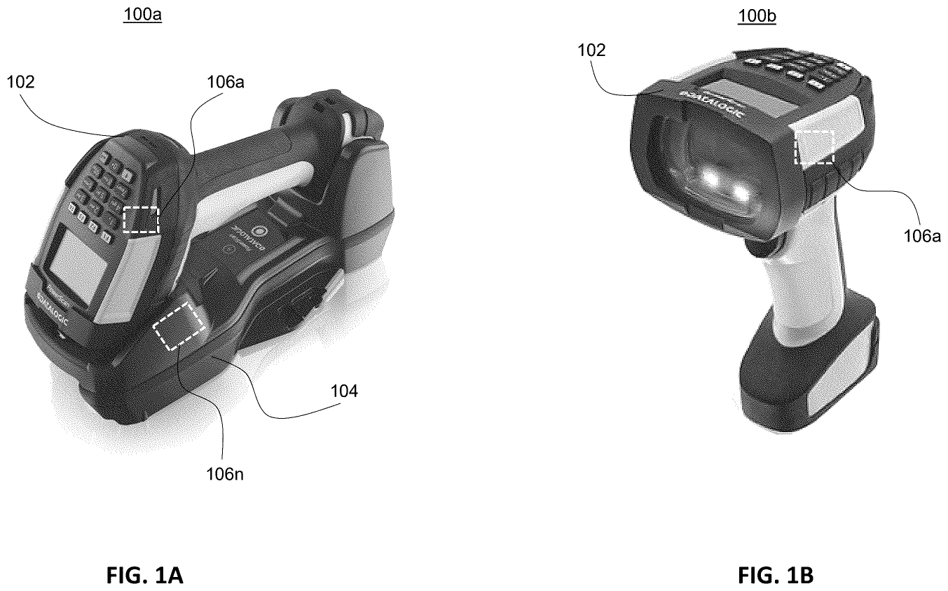

With regard to FIGS. 1A and 1B, illustrations of an illustrative handheld barcode reader system 100a and 100b with a handheld barcode reader 102 and a docking/charging station 104 are shown. The handheld barcode reader 102 and docking/charging station 104 may have electrical components 106a-106n (collectively 106) that may be monitored to determine potential or actual faults, as further described herein. The handheld barcode reader 102 may be connected to the docking station 104 to charge a rechargeable battery of the handheld barcode reader 102. The handheld barcode reader 102 may also be oriented upright and independent of the docking station 104 in preparation for performing a scan, as shown in 100b. A typical electronic or electrical device that fails is a power converter used during recharging of the rechargeable battery of the handheld barcode reader 102. Other electrical devices are prone to failure, so utilizing the principles described herein may help avoid catastrophic failure.

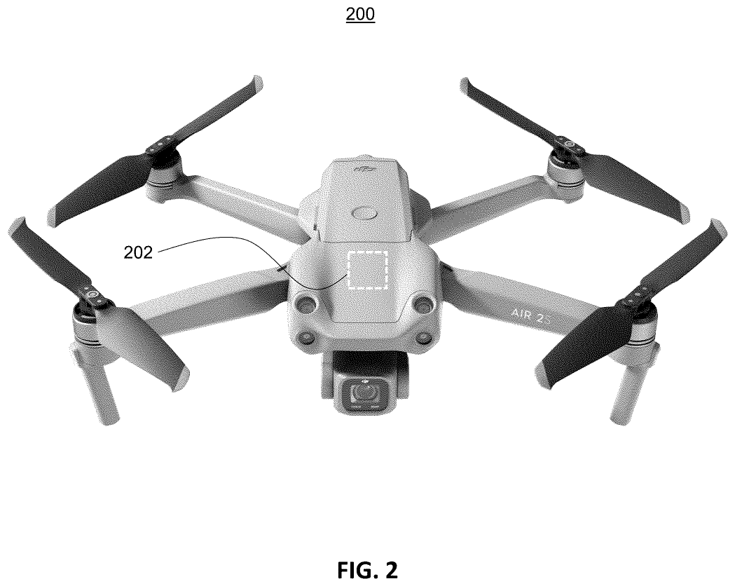

With regard to FIG. 2, an illustration of an illustrative system 200, in this case an unmanned arial device (UAV) (e.g., drone), with a number of electrical components 202, is shown. As with the barcode reader system 100a of FIG. 1A, the system 200 may have one or more electrical components to monitor so as to either identify or predict a potential failure of an electrical component or determine a failed electrical component. A notification and corrective action may be generated and communicated to a user.

Other electronic devices, particularly those including barcode readers, scanners, sensors, imaging systems, etc. having electrical components that are monitored to identify or predict a potential failure thereof are also contemplated and within the scope of embodiments of the disclosure. Such barcode readers may also have different form factors, such as, for example, mobile computers integrated with scan engines, bi-optic scanners or single plane scanners often used in retail environments during checkout, presentation scanners, among other similar devices.

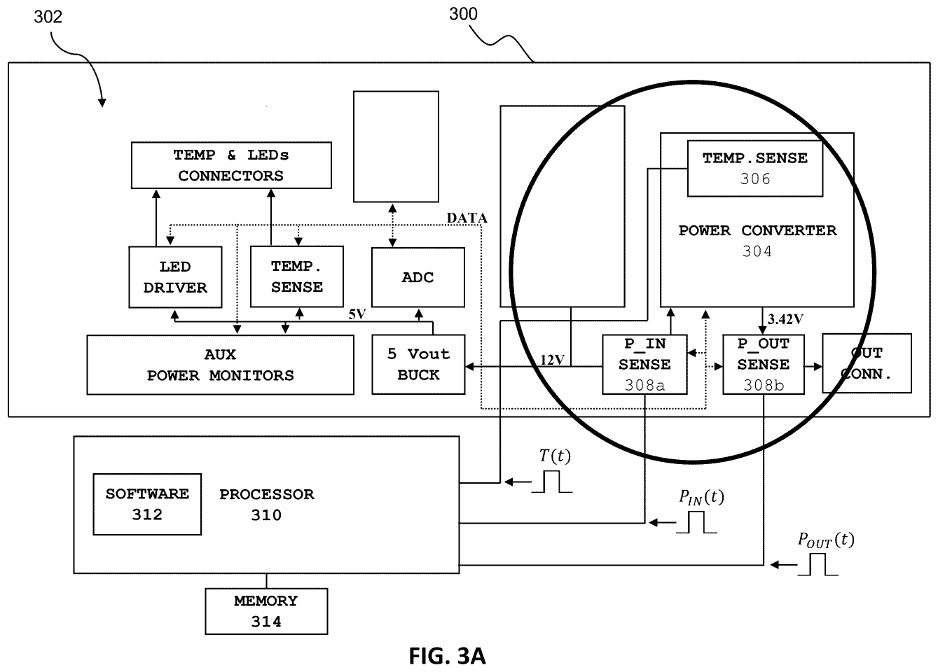

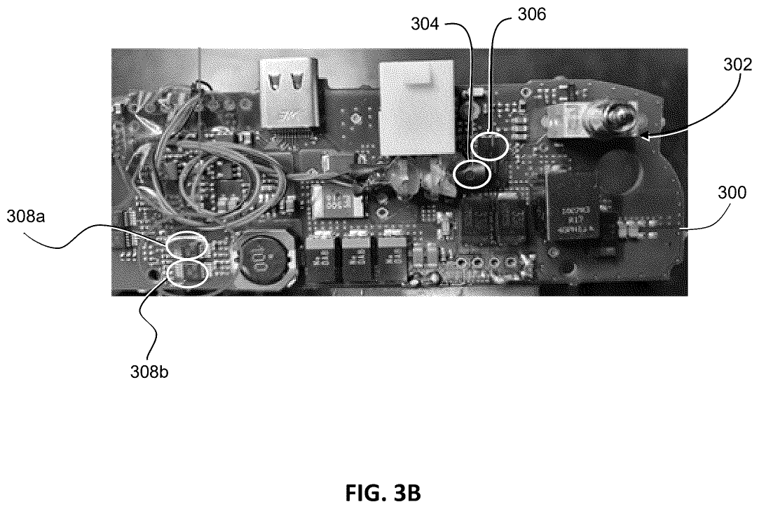

With regard to FIGS. 3A and 3B, (i) a block diagram of a printed circuit board (PCB) 300 and (ii) an illustration of an illustrative PCB 300 are shown. The PCB 300 includes an electrical circuit with electronics 302 that include a power converter 304. The electronics 302 may include a temperature sensor 306, an input power sensor 308a, and an output power sensor 308b configured and arranged to sense operating parameters of the power converter 304. The temperature sensor 306 may be any temperature sensor (e.g., Datalogic PT100, generic thermocouple), but may alternatively or additionally use an internal temperature sensor of an electrical component. The temperature sensor 306 and power sensors 308 are configured to sense and output respective electronic signals T(t), P_{IN}(t), and P_{OUT}(t) over time corresponding their respective temperature and power measurements to a processor 310 or other circuitry for storage and processing thereby. The processor 310 may utilize the received electrical signals T(t), P_{IN}(t), and P_{OUT}(t) during one or more processes when executing software 312 to perform a potential or actual failure analysis of components being sensed. The processor 310 may be in electrical communication with memory 314 for use during and after the failure analysis.

The hardware and data processing components, such as the processor 310, software 312, and memory 314, may be used to implement the various processes described herein. In an alternative embodiment, a processor may be remotely located from the system and perform the processes described herein.

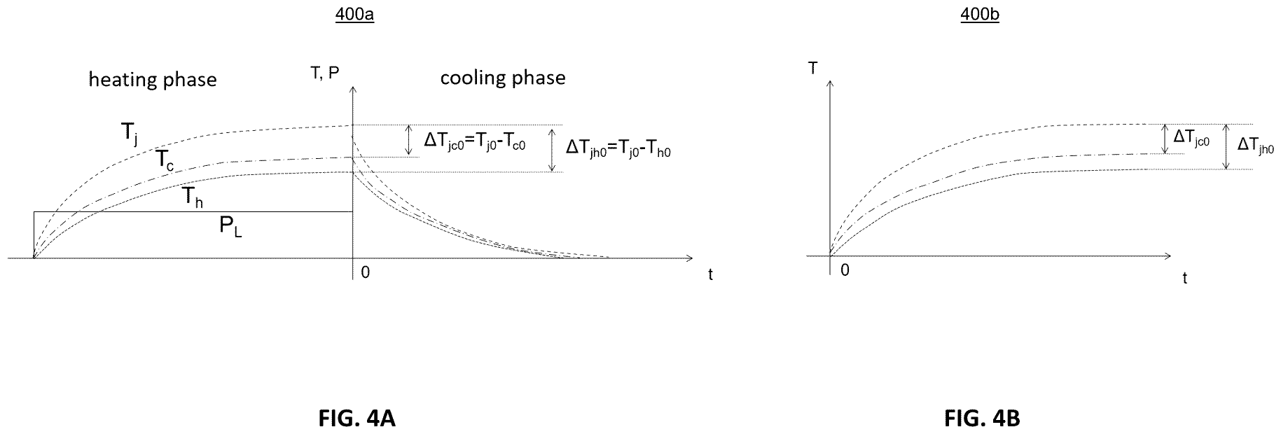

With regard to FIGS. 4A and 4B, illustrations of illustrative temperature and power plots 400a and 400b used to describe thermal resistance and impedance calculations are shown. Thermal resistance (Rₜₕ or R_{th(x-y)}) of a given electrical system or component may be determined by calculating a difference (ΔT_{xy}_{₀}) between two temperatures of the electrical system or component (T_{xθ} and T_{y}_{₀}) at a specific point in time (t=0) and dividing the result (ΔT_{xy}_{₀}) by the measured power losses (P_{L}) across the electrical system or component.

$${R}_{th ( x - y )} = \frac{Δ {T}_{{xy}_{0}}}{{P}_{L}} \qquad ( EQ . 1 )$$

For example, considering temperature and power plot 400a, thermal resistance (Rₜₕ₍ⱼ₋ₕ₎) may be determined by calculating the difference (ΔTⱼₕ_{₀}) between Tⱼ_{₀} and Tₕ_{₀} at time t=0 and dividing the result by the power losses (P_{L}) at time t=0.

Temperature and power plot 400a includes a heating phase (−∞≤t≤0 when temperature T is continuously increasing) and a cooling phase (0≤t<∞ when temperature T is continuously decreasing). The portion of the plot corresponding to the cooling phase may be transformed to represent the time-dependent thermal impedance (Z_{th(x-y)}(t)) of the electrical system or component. The thermal impedance of an electrical system or component may be determined by calculating the time-dependent difference between two temperatures of the electrical system or component (ΔT_{xy}(t)) and dividing the result by the power losses (P_{L}) across the electrical system or component.

$${Z}_{th ( x - y )} ( t ) = \frac{Δ {T}_{xy} ( t )}{{P}_{L}} \qquad ( EQ . 2 )$$

Thermal resistance (Rₜₕ or R_{th(x-y)}) and thermal impedance Z_{th(x-y)}(t)) are illustrative examples of time-based measurements (or time-dependent measurements) that may vary as a function of time t and may be calculated from the sensed input electrical power, sensed output electrical power, and/or sensed temperature of the electrical system or component(s). In some embodiments, other time-based measurements may be utilized for these purposes.

Temperature plot 400b shows the time-dependent thermal impedance Z_{th(x-y)}(t) of the electrical system or component used in temperature and power plot 400a. To generate temperature plot 400b, the temperature curves Tⱼ, T_{c}, and Tₕ of FIG. 4A corresponding the cooling section of temperature and power plot 400a may be mirrored horizontally and shifted to align with the origin of the coordinate system, as shown in FIG. 4B.

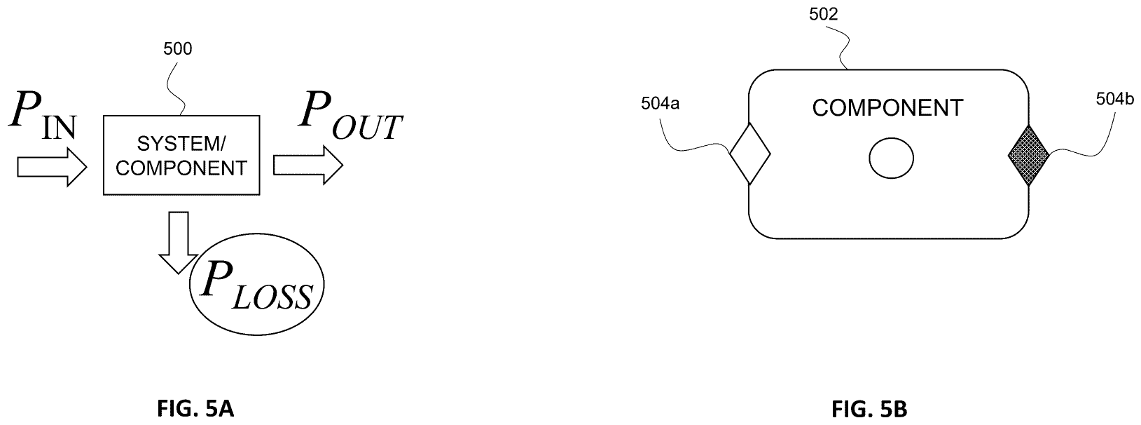

With regard to FIGS. 5A and 5B, block diagrams of (i) an illustrative electrical system or component 500 showing input power P_{IN}, output power P_{OUT}, and power losses P_{LOSS} and (ii) an illustrative electrical component 502 inclusive of an input power sensor 504a and an output power sensor 504b are shown. Referring to FIG. 5A, power losses (P_{L} or P_{LOSS}) may be determined by calculating the difference between the input power P_{IN} and the output power P_{OUT} across an electrical system or component 500.

$${P}_{LOSS} = {P}_{IN} - {P}_{OUT} \qquad ( EQ . 3 )$$

For example, power losses P_{LOSS} across an electrical component 502 may be determined by measuring the input power P_{IN} to the electrical component with input power sensor 504a and by measuring the output power P_{OUT} to the electrical component with output power sensor 504b and then calculating the difference (P_{LOSS}=P_{IN}−P_{OUT}) between the measured input power P_{IN} and the measured output power P_{OUT}.

Power losses are responsible for heat generation due to the Joule Effect and are inversely proportional to system or component efficiency (η). Thus, at a fixed input power P_{IN}, an increase in power losses leads to a decrease in efficiency of the electrical component 502, as described by:

$${P}_{LOSS} = {P}_{IN} - {P}_{OUT} \qquad ( EQ . 4 )$$

$${P}_{LOSS} = {P}_{IN} ( 1 - η ) \qquad ( EQ . 5 )$$

$${P}_{LOSS} ∝ 1 - η \qquad ( EQ . 6 )$$

The thermal resistance Rₜₕ of an electrical system or component depends on intrinsic thermal characteristics of the electrical system/component. Accordingly, a minimum electrical system/component thermal resistance (R_{th MIN}) may be determined by calculating the minimum temperature variation in the system/component due to minimum losses (ΔT_{MIN}) and dividing this value by the minimum power losses observed when the system/component is operating (P_{L MIN}).

$${R}_{th MIN} = \frac{Δ {T}_{MIN}}{{P}_{L MIN}} \qquad ( EQ . 7 )$$

After determining the minimum electrical system/component thermal resistance R_{th MIN}, any subsequent variations in thermal resistance Rₜₕ may indicate a potential or actual fault associated with the electrical system or component. The maximum efficiency for each electrical system or component being analyzed (η_{MAX}) may also be known and used in this determination.

For example, consider a scenario in which the thermal resistance of an electrical system/component increases (Rₜₕ>R_{th MIN}) while power losses remain at a minimum level (P_{LOSS}=P_{L MIN}). In this scenario, the temperature difference increases (ΔT>ΔT_{MIN}) because thermal resistance Rₜₕ is increasing and power losses P_{LOSS} are not changing. Here, an increase in thermal resistance (and corresponding increase in ΔT) while power losses remain at a minimum suggests poor or bad heat dissipation of the electrical system/component being analyzed (e.g., dust accumulation).

As another example, consider a scenario in which the thermal resistance Rₜₕ of a system/component increases (Rₜₕ>R_{th MIN}) while power losses P_{LOSS} also increase (P_{LOSS}>P_{L MIN}). If the output power P_{OUT} is at a fixed level (P_{OUT}=C, where C is a constant variable), then an increase in thermal resistance Rₜₕ may occur as power losses P_{LOSS} become higher than minimum losses P_{L MIN}, or it may occur following a decrease in system/component efficiency (η<η_{MAX}). An increase in power losses P_{LOSS} induces a higher Joule effect on the electrical system/component being analyzed, which causes an increase in temperature change (ΔT>ΔT_{MIN}) as a secondary effect. Thus, in this scenario, an increase in thermal resistance (and corresponding increase in ΔT) while power losses also increase (thus causing a decrease in efficiency) suggests poor or bad electrical functionality of the system/component being analyzed. It should be understood that the electrical component 502 may be any type of electrical component or multiple electrical components.

Table 1 below summarizes the correlation between temperature and efficiency and shows potential diagnoses (e.g., bad heat dissipation) based on the relationship between these variables.

TABLE 1
Electrical Device Characteristics and Diagnoses

| Thermal Resistance (Rₜₕ) | Efficiency (η) | Diagnosis |
|---|---|---|
| Increase | Nominal | Bad heat dissipation |
| | Lower than nominal | Bad electrical |
| | | functionality |

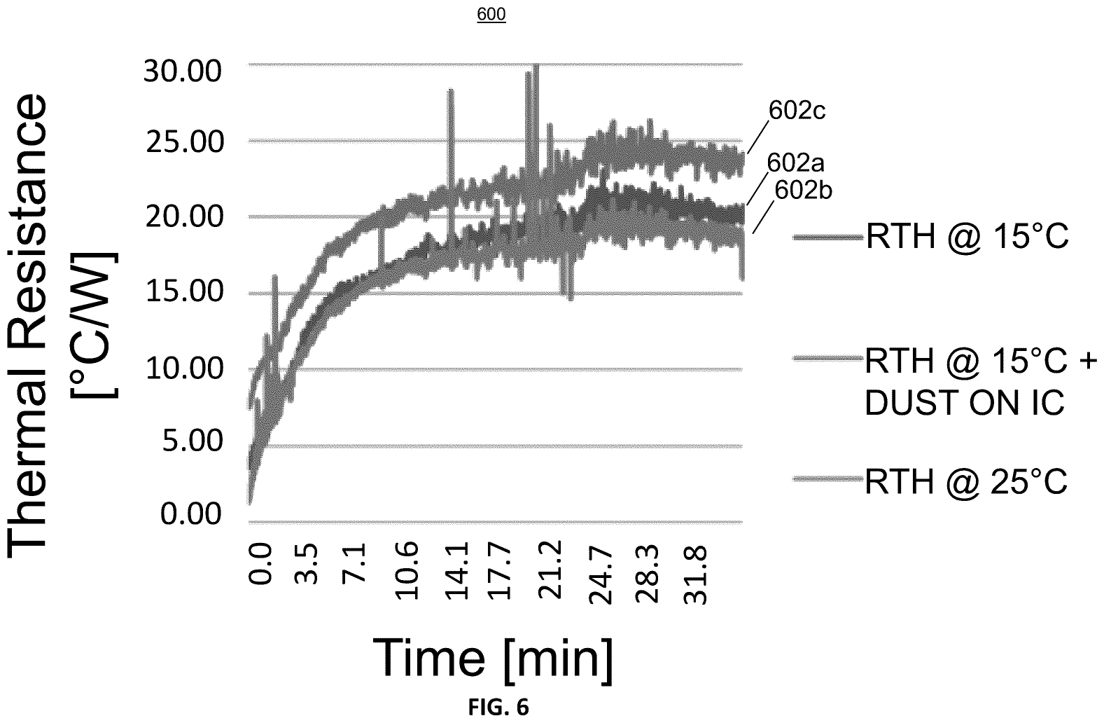

With regard to FIG. 6, an illustration of an illustrative thermal resistance plot 600 for an electrical system or component over a range of distinct temperatures and conditions is shown. For example, consider an electrical component 502 (FIG. 5) with distinct thermal resistance data sets 602a-602c (collectively 602) corresponding to (i) the thermal resistance data set 602a of the electrical component over time at an ambient temperature (T_{AMB}) of fifteen degrees Celsius, (ii) the thermal resistance data set 602b at an ambient temperature of twenty-five degrees Celsius, and (ii) the thermal resistance data set 602c at an ambient temperature of fifteen degrees Celsius with dust placed on the electrical component. Here, the thermal resistance data 602a at T_{AMB}=15° C. may serve as the minimum thermal resistance (R_{th MIN}) of the electrical component 502. When the ambient temperature is increased, the thermal resistance data 602b at T_{AMB}=25° C. varies minimally from the minimum thermal resistance data 602a (both partially overlap). However, the thermal resistance data 602c at T_{AMB}=15° C. with dust added to the electrical component varies significantly (e.g., more than about 5% or about 10%) from the minimum thermal resistance data 602a. Assuming all measurements were conducted at nominal efficiency, the relative increase associated with thermal resistance data 602c suggests that the electrical component is experiencing poor heat dissipation due to the dust on the electrical component. This increase in thermal resistance is an expected result considering the addition of dust on the surface of the electrical component in this scenario.

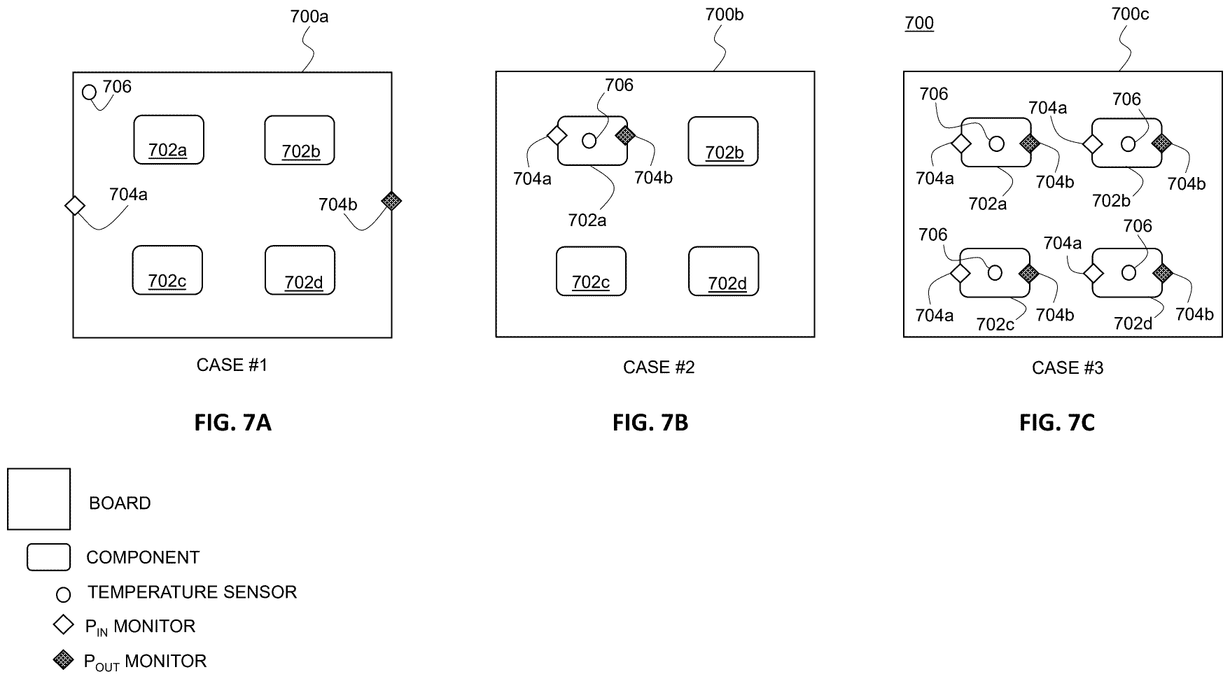

With regard to FIGS. 7A, 7B, block diagrams showing various illustrative systems 700a-700c (collectively 700) inclusive of a group of electrical components 702a-702d (collectively 702) being sensed by input power sensors 704a, output power sensors 704b, and temperature sensors 706 is shown. The sensors 704a, 704b, and 706 may be used to determine the thermal resistance of (i) the system 700a, (ii) the electrical component 702a, and (iii) the group of electrical components 702.

In FIG. 7A, the system 700a with electrical components 702 is shown. The input power sensor 704a and the output power sensor 704b may be configured to monitor respective input and output electrical powers of the system 700a (in this case a printed circuit board with the electrical components 702 disposed thereon) as a whole rather than monitoring one or more of the electrical components 702. Although the system 700a is shown to be a printed circuit board, any other configuration of a system (e.g., multiple printed circuit boards, multiple components disposed in a chassis, etc.) may be monitored by the input power sensor 704a, output power sensor 704b, and the temperature sensor 706, and each of the sensors 704a, 704b, and 706 may be configured to monitor the system as a whole rather than monitoring one or more of the electrical components. The temperature sensor 706 may be configured to monitor temperature of the system 700a rather than monitoring one or more of the electrical component(s) 702. Data collected from the power sensors 704 and the temperature sensor 706 may be used to calculate thermal resistance of system 700a, which provides high level information related to the behavior of the system 700a. The sensing may be performed over a time period so that behavior changes of one or more of the electrical components 702 may be determined.

In FIG. 7B, the system 700b with the electrical components 702 is shown. The input power sensor 704a and the output power sensor 704b may be configured to monitor the input and output electrical power, respectively, of the electrical component 702a. The temperature sensor 706 may be configured to monitor temperature of the electrical component 702a. In an embodiment, the temperature sensor 706 may be physically connected to the electrical component 702a. Data collected from the power sensors 704 and the temperature sensor 706 may be used to calculate thermal resistance of the electrical component 702a, which provides local information about the behavior of a single electrical component within the system 700b.

In FIG. 7C, the system 700c with the electrical components 702 is shown. The input power sensors 704a and the output power sensors 704b may be configured to monitor the input and output electrical power, respectively, of each of the electrical components 702. The temperature sensors 706 may be configured to monitor the temperatures of each of the electrical components 702. Data collected from the power sensors 704 and the temperature sensors 706 may be used to calculate the thermal resistances of each of the electrical components 702, which provides local information about the behavior of multiple electrical components within the system 700c.

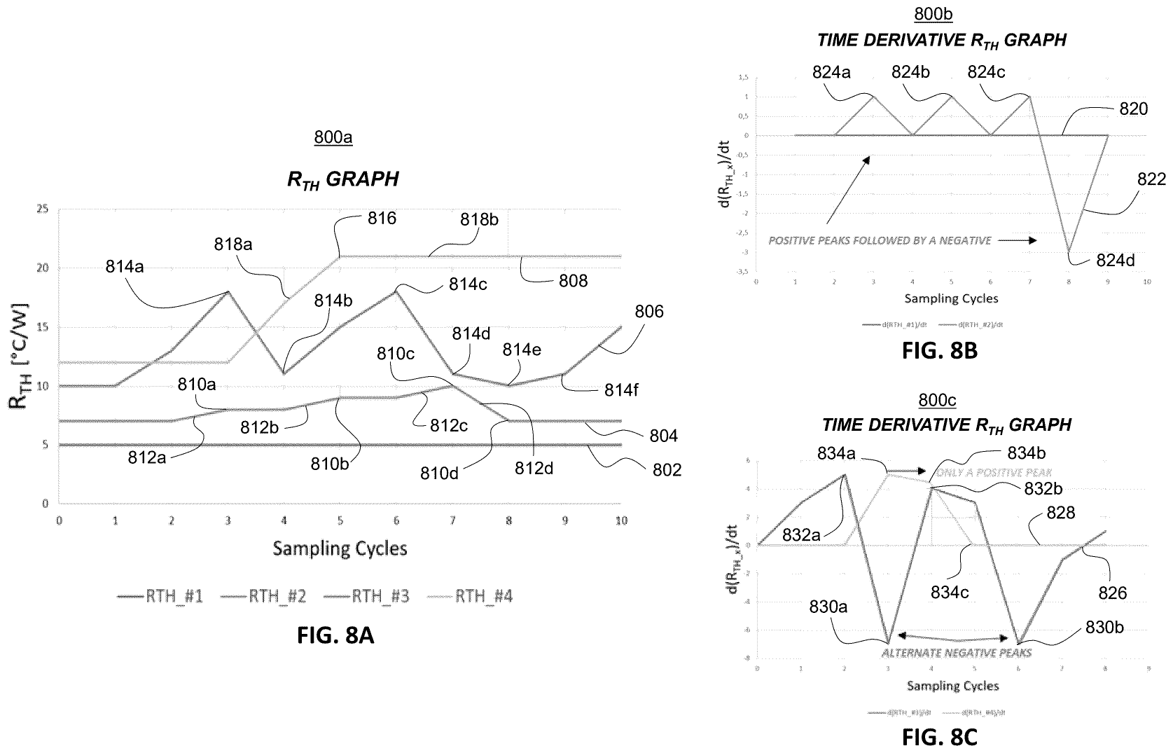

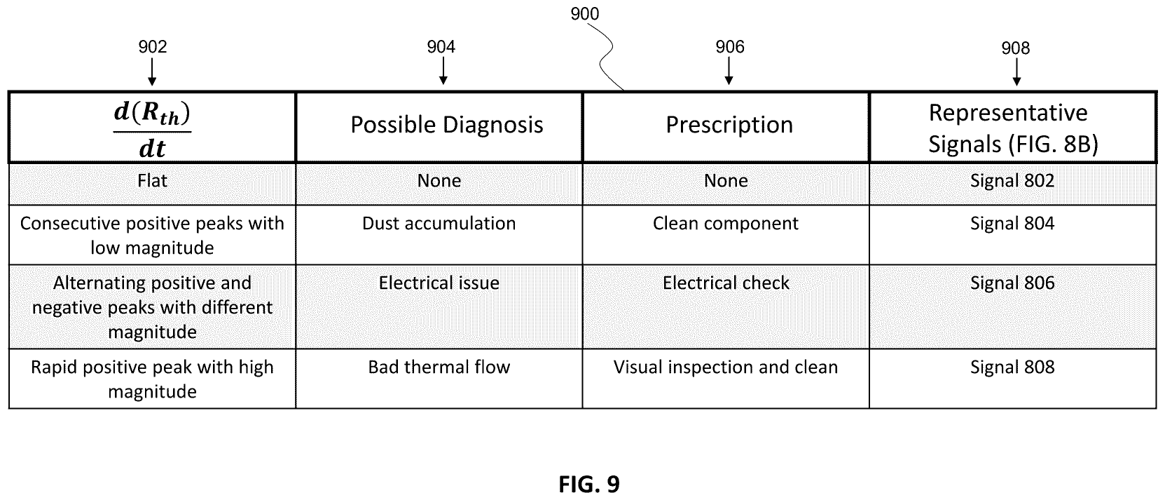

For example, the system 700c may be a fan grid including a number of fan elements 702a-702d (collectively 702) that may be monitored by input power sensors 704a, output power sensors 704, and temperature sensors 706. Data collected from the power sensors 704 and the temperature sensors 706 may be used to calculate the thermal resistances of each of the fan elements 702, which provides local information about the behavior of each fan within the fan grid 700c. If, for example, the thermal resistance values for the fan elements 702 show significant variation (e.g., more than about 5% or about 10%), a message of “clean fan grid” may be sent to a user. Other behaviors, diagnoses, and prescriptions may be determined as described with regard to FIGS. 8A-8C and FIG. 9.

With regard to FIGS. 8A, 8B, and 8C, illustrations of illustrative plots 800a-800c (collectively 800) for an electrical system or component showing the changes in the thermal resistance of the system or component over time are shown. Although the plots 800 are shown to be time derivatives (i.e., using a derivative function over time), it should be understood that alternative computational analyses may be utilized to describe behavior of the electrical component(s) being sensed.

In FIG. 8A, an Rₜₕ plot 800a with thermal resistance data 802, 804, 806, and 808 is shown. The thermal resistance data 802, 804, 806, and 808 correspond with thermal resistance variation of the electrical components 702a-702d from FIG. 7C, respectively. The thermal resistance data 802 corresponds to the thermal resistance of the electrical component 702a from FIG. 7C and is plotted on an Rₜₕ plot 800a. As shown, the thermal resistance data 802 is a flat line with no positive or negative peaks. The thermal resistance data 804 corresponds to the thermal resistance of the electrical component 702b from FIG. 7C and is plotted on the Rₜₕ plot 800a. As shown, the thermal resistance data 804 has positive peaks 810a-810c and negative peak 810d. Each of the positive peaks 810a-810c are preceded by respective transitional increasing data ranges 812a-812c, and the negative peak 810d is preceded by a transitional decreasing data range 812d. The thermal resistance data 806 corresponds to the thermal resistance of the electrical component 702c from FIG. 7C and is plotted on the Rₜₕ plot 800a. As shown, the thermal resistance data 806 has positive peaks 814a and 814c, which alternate with negative peaks 814b, 814d, 814e, and 814f. The thermal resistance data 808 corresponds to the thermal resistance of the electrical component 702a from FIG. 7C and is plotted on the Rₜₕ plot 800a. As shown, the thermal resistance data 808 has a single positive peak 816 that is preceded by a transitional decreasing data range 818a and followed by a transitional flat data range 818b.

In FIG. 8B, a time derivative Rₜₕ plot 800b with derivative thermal resistance data 820 and 822 is shown. The derivative thermal resistance data 820 corresponds to the thermal resistance of electrical component 702a from FIG. 7C and the thermal resistance data 802 from the Rₜₕ plot 800a. The derivative thermal resistance data 820 is plotted on the time derivative Rₜₕ plot 800b. As shown, the derivative thermal resistance data 820 is a flat line with no positive or negative peaks, which is not indicative of the electrical component exhibiting a certain behavior that may represent a potential or actual fault.

The thermal resistance data 822 corresponds to the thermal resistance of electrical component 702b from FIG. 7C and the thermal resistance data 804 from the Rₜₕ plot 800a. The thermal resistance data 822 is plotted on the time derivative Rₜₕ plot 800b. As shown, the derivative thermal resistance data 822 has three consecutive positive peaks 804a-804c and a single negative peak 804d, which is indicative of the electrical component exhibiting a certain behavior that may represent a potential or actual fault.

In FIG. 8C, a time derivative Rₜₕ plot 800c with derivative thermal resistance data 826 and 828 is shown. The derivative thermal resistance data 826 corresponds to the thermal resistance of electrical component 702c from FIG. 7C and the thermal resistance data 806 from the Rₜₕ plot 800a. The derivative thermal resistance data 826 is plotted on the time derivative Rₜₕ plot 800c. As shown, the derivative thermal resistance data 826 has alternating negative peaks 830a and 830b and positive peaks 832a and 832b, which is indicative of the electrical component exhibiting a certain behavior that may represent a potential or actual fault.

The thermal resistance data 828 corresponds to the thermal resistance of electrical component 702d from FIG. 7C and the thermal resistance data 808 from the Rₜₕ plot 800a. The thermal resistance data 828 is plotted on the time derivative Rₜₕ plot 800c. As shown, the derivative thermal resistance data 828 has a single positive peak 834a followed by points 834b and 834c, which is indicative of the electrical component exhibiting a certain behavior that may represent a potential or actual fault.

With regard to FIG. 9, an illustration of an illustrative lookup table 900 containing derivative thermal resistance behaviors 902, possible diagnoses 904, prescriptive actions 906, and representative signals 908 (corresponding to thermal resistance data 802, 804, 806, and 808 from FIG. 8B) is shown. The derivative thermal resistance behavior 902 may be described using natural language (e.g., “Flat,” “Consecutive positive peaks with low magnitude,” “Alternating positive and negative peaks with different magnitude,” and “Random positive peak with high magnitude”). The possible diagnoses 904 may be described using natural language (e.g., “None,” “Dust accumulation,” “Electrical Issue,” and “Bad thermal flow”). The prescriptive actions (or “prescriptions”) may be described using natural language (e.g., “None,” “Clean component,” “Electrical check,” and “Visual inspection and clean”).

The representative signals 908, which include signals 802, 804, 806, and 808 from FIG. 8B, may be categorized as one of the derivative thermal resistance behaviors 902 using natural language processing. Based on identifying the behaviors 902, a possible diagnosis 904 corresponding to the relevant derivative thermal resistance behavior 902 may be identified and displayed or communicated to a user. Further, a possible prescriptive action (or “prescription”) 906 corresponding to the relevant derivative thermal resistance behavior 902 may be identified and a signal or message may be generated, communicated, and displayed to the user.

For example, consider signal 802 as the representative signal 908. Recall that signal 802 (shown on FIG. 8A as a flat line) corresponds with the derivative thermal resistance data 820 (shown on FIG. 8B as a flat line), which corresponds with the thermal resistance of electrical component 702a (shown on FIG. 7C). As shown, the derivative thermal resistance data 820 is a flat line with no positive or negative peaks. Thus, the signal 802 may be categorized as having “Flat” derivative thermal resistance behavior 902. Based on this result or behavior identification, the corresponding diagnosis 904 (“None”) and corresponding prescriptive action 906 (“None”) may be identified, generated, communicated, and displayed to a user. The identification of the behaviors may be made using a behavior matching look-up table, pattern matching algorithm, or otherwise.

As another example, consider signal 804 as the representative signal 908. Recall that signal 804 (shown on FIG. 8A) corresponds with the derivative thermal resistance data 822 (shown on FIG. 8B), which corresponds with the thermal resistance of electrical component 702b (shown on FIG. 7C). As shown, the derivative thermal resistance data 822 has three consecutive positive peaks 824a-824c and a single negative peak 824d. The presence of multiple consecutive positive peaks suggests that the thermal resistance of electrical component 702b is slowly increasing. Thus, the signal 804 may be categorized as having “Consecutive positive peaks with low magnitude” derivative thermal resistance behavior 902. Based on this result, the corresponding diagnosis 904 (“Dust accumulation”) and corresponding prescriptive action 906 (“Clean component”) may be identified, generated, communicated, and displayed to a user.

Derivative thermal resistance data 828 (from FIG. 8B) offers an illustrative example of derivative thermal resistance data following a successful identification of an actual or potential fault, notification of a user, and performance of an associated prescriptive action. For example, assume that the time (t) value of positive peak 824c corresponds to the point in time when a fault in electrical component 702b (from FIG. 7C) was identified and when an operator performed the corresponding prescriptive action (“clean component”). As shown on FIG. 8B, positive peaks 824a-824c are followed by a negative peak 824d with a magnitude approximately equal to the sum of the magnitudes of positive peaks 824a-824c, representing a change in the derivative thermal resistance value of component 702b as it returns to its baseline (or pre-fault) state. The transitional decreasing data portion between positive peak 824c and 824d represents the change in derivative thermal resistance of component 702b after the potential or actual fault has been resolved and the thermal resistance of component 702b is decreasing and returning to its pre-fault state.

As another example, consider signal 806 as the representative signal 908. Recall that signal 806 (shown on FIG. 8A) corresponds with the derivative thermal resistance data 826 (shown on FIG. 8B), which corresponds with the thermal resistance of electrical component 702c (shown on FIG. 7C). As shown, the derivative thermal resistance data 826 has negative peaks 830a and 830b, which alternate with positive peaks 832a and 832b. Thus, the signal 806 may be categorized as having “Alternating positive and negative peaks with different magnitude” derivative thermal resistance behavior 902. Based on this result, the corresponding diagnosis 904 (“Electrical issue”) and corresponding prescriptive action 906 (“Electrical check”) may be identified, generated, communicated, and displayed to a user.

As another example, consider signal 808 as the representative signal 908. Recall that signal 808 (shown on FIG. 8A) corresponds with the derivative thermal resistance data 828 (shown on FIG. 8B), which corresponds with the thermal resistance of electrical component 702d (shown on FIG. 7C). As shown, the derivative thermal resistance data 828 includes a rapid positive peak 834a and other points 834b and 834c. The rapid positive peak 834a has a higher magnitude than points 834b and 834c. Thus, the signal 806 may be categorized as having “Rapid positive peak with high magnitude” derivative thermal resistance behavior 902. Based on this result, the corresponding diagnosis 904 (“Bad thermal flow”) and corresponding prescriptive action 906 (“Visual inspection and clean”) may be identified, generated, communicated, and displayed to a user. It should be understood that additional and/or alternative derivative thermal resistance behaviors may be included along with corresponding possible diagnoses and prescriptions based on different signals with different features.

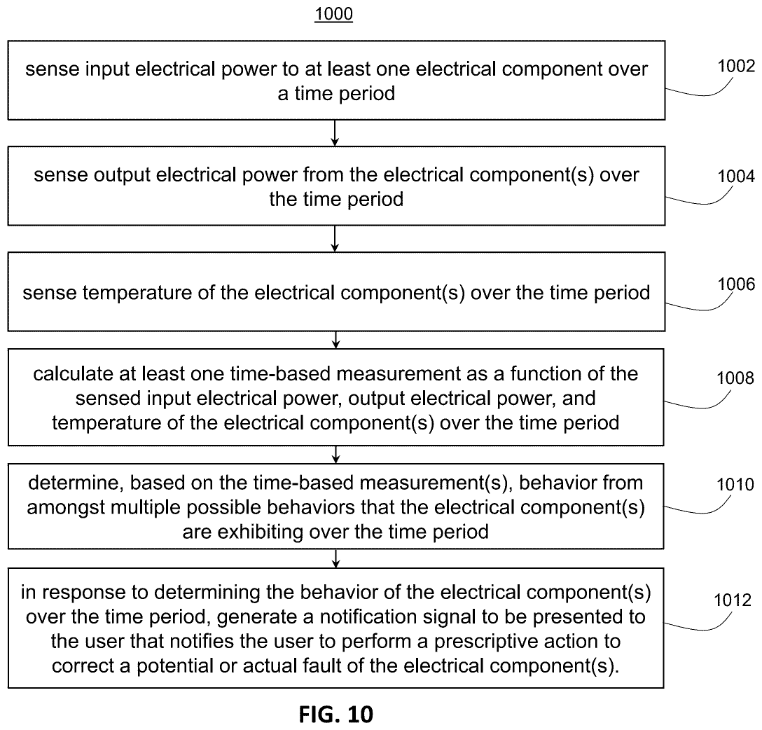

With regard to FIG. 10, a block diagram of an illustrative process 1000 for notifying a user of a potential or actual fault of at least one electrical component is shown. The process 1000 may include sensing input electrical power to the electrical component(s) over a time period at step 1002, sensing input electrical power to the electrical component(s) over the time period at step 1004, and sensing temperature of the electrical component(s) over the time period at step 1006. The process 1000 may further include calculating 1008 at least one time-based measurement as a function of the sensed input electrical power, output electrical power, and temperature of the electrical component(s) over the time period. At step 1010, behavior from amongst multiple possible behaviors that the electrical component(s) are exhibiting over the time period may be determined. In response to determining the behavior of the electrical component(s) over the time period, a notification signal to be presented to the user that notifies the user to perform a prescriptive action to correct the potential or actual fault of the electrical component(s) may be generated at step 1012. The process 1000 may be performed by an onboard or offboard processor (or other circuit) and display or communicate a notification for a user on the system or to another device (e.g., e-mail or text to an e-mail account to be read on a computer or mobile device).

The illustrative embodiments included herein and wherein relate to a temperature-efficiency correlator for fault prevention and/or detection of electrical components. In particular, one embodiment relates to a computer-implemented method of notifying a user of a potential or actual fault of at least one electrical component. This process may include sensing (i) input electrical power component(s), (ii) sensing output electrical power from the electrical component(s), and (iii) sensing temperature of the electrical component(s) over a time period. At least one time-based measurement may be calculated as a function of the sensed input electrical power, output electrical power, and temperature of the electrical component(s) over the time period. A determination, based on the time-based measurement, may be made of behavior from amongst multiple possible behaviors that the electrical component(s) are exhibiting over the time period. In response to determining the behavior of the electrical component(s) over the time period, a notification signal may be generated and presented to the user that notifies the user to perform a prescriptive action to correct the potential or actual fault of the electrical component(s).

According to another illustrative embodiment, calculating at least one time-based measurement may include calculating (i) thermal resistance over the time period and (ii) a derivative of the thermal resistance over the time period of the electrical component(s).

Generating a notification signal may include illuminating at least one illumination device indicative of the prescriptive action to be taken. The illumination device may be a light-emitting diode (LED) or any other device, system, or apparatus capable of generating an illumination signal (or light signal) that may be presented to a user. Although an illumination device may be used to present a notification signal to a user, it should be understood that alternative devices, systems, processes, and methods (e.g., e-mail, text message) may be utilized to present a notification signal to a user.

Generating a notification signal may include generating text descriptive of the potential or actual fault to be displayed on an electronic display, and the step may further include communicating the text to be displayed on an electronic device for a user to view. The electronic display may include an LED display, a liquid-crystal display (LCD), or any other device, system or apparatus capable of allowing text descriptive of the potential or actual fault to be displayed to a user.

Data indicative of the multiple possible behaviors that the electrical component(s) exhibit over time may be stored. The data indicative of the multiple possible behaviors may include data defined by derivative functions of changes in thermal resistance of the electrical component(s) over time. Determining behavior from amongst multiple possible behaviors may include determining which data indicative of the multiple possible behaviors most closely represents the calculated time-based measurement(s) of the electrical component(s) over the time period.

In another embodiment, storing data indicative of the multiple possible behaviors may include storing metadata descriptive of the data defined by derivative functions of changes in thermal resistance of the at least one electrical component over time. The metadata may be determined by a processor that identifies the behavior of a derivative signal.

Another embodiment may further include storing a table inclusive of the metadata in independent records. The metadata may include data that describes sensed electrical device(s), such as at least one of (i) “flat,” (ii) “consecutive positive peaks with low magnitude,” (iii) “alternating positive and negative peaks with different magnitude,” and (iv) “rapid positive peak with high magnitude.”

In another illustrative embodiment, storing the data indicative of the multiple possible behaviors may further include storing possible diagnoses and prescriptions in association with each of the respective possible behaviors, and generating text may include selecting an associated prescription with the determined behavior.

Determining behavior from amongst multiple possible behaviors may include determining behavior locally on a device in which the electrical component(s) are operating.

Sensing input electrical power, output electrical power, and temperature from the electrical component(s) over time may include sensing input electrical power, output electrical power, and temperature from electrical component(s) over time of a power converter contained within a handheld electronic device.

Another embodiment relates to a system including at least one input power sensor configured to sense input electrical power to at least one electrical component over a time period, at least one output power sensor configured to sense output electrical power from the electrical component(s) over the time period, and at least one temperature sensor configured to sense temperature from the electrical component(s) over the time period. The system further includes at least one processor configured to receive communications signals from the sensors. The processor(s) may be configured to calculate at least one time-based measurement as a function of the sensed input electrical power, output electrical power, and temperature of the electrical component(s) over the time period. The processor(s) may be configured to determine, based on the at least one-time based measurement, behavior from amongst multiple possible behaviors that the electrical component(s) may be exhibiting over the time period. In response to determining the behavior of the electrical component(s) over the time period, the processor(s) may further be configured to generate a notification signal to be presented to the user that notifies the user to perform a prescriptive action to correct a potential or actual fault of the electrical component(s) based on the determined behavior.

The processor(s), in calculating the time-based measurement(s), may be further configured to calculate (i) thermal resistance over the time period and (ii) a derivative of the thermal resistance over the time period of the electrical component(s).

The input power sensor and the output power sensor may be configured to monitor respective input and output electrical powers of the system, and the temperature sensor may be configured to monitor the temperature of the system as a whole rather than monitoring one or more of the electrical components. The system may be a PCB or other component and/or structure that supports one or more of the electrical components.

The input power sensor and the output power sensor may be configured to monitor the input and output electrical power, respectively, and the temperature sensor may be configured to monitor the temperature of an individual electrical component.

In an embodiment, multiple input power sensors, output power sensors, and temperature sensors may be configured to monitor (i) the input and (ii) output electrical power, and (iii) the temperatures, of a group of respective individual electrical components. The processor may be further configured to compare measured input power, output power, and temperatures of respective individual electrical components with one another to determine differences between respective measurements, and in response to determining that a difference above a threshold level between the measurements of the respective individual electrical components exists, generate a second notification signal to be presented to the user that notifies the user to perform a prescriptive action to correct the potential or actual fault of at least one of the respective individual electrical components.

The processor(s) may be configured to generate a notification signal by illuminating at least one illumination device indicative of the prescriptive action to be taken.

The processor(s) may be further configured to (i) generate a notification signal by generating text descriptive of the potential or actual fault to be displayed on an electronic display and (ii) communicate the text to be displayed on an electronic device for a user to view.

The processor(s) may be further configured to store data indicative of the multiple possible behaviors that the electrical component(s) exhibit over time. The data indicative of the multiple possible behaviors may include data defined by derivative functions of changes in thermal resistance of the electrical component(s) over time. The processor(s) may be further configured to determine behavior from amongst multiple possible behaviors by determining which data indicative of the multiple possible behaviors most closely represents the calculated time-based measurement(s) of the electrical component(s) over the time period.

The processor(s), in storing data indicative of the multiple possible behaviors, may be configured to store metadata descriptive of the data. The metadata may be defined by derivative functions of changes in thermal resistance of the electrical component(s) over time.

A non-transitory memory may be in communication with the processor(s) and be configured to store at least one table inclusive of the metadata stored in independent records. The metadata may include at least one of (i) flat, (ii) consecutive positive peaks with low magnitude, (iii) alternating positive and negative peaks with different magnitude, and (iv) rapid positive peak with high magnitude.

The processor(s) may be configured to store possible diagnoses and prescriptions in association with each of the respective possible behaviors and further configured to select an associated prescription with the determined behavior when generating text.

The processor(s) may be locally operating on a device in which at the electrical component(s) are operating.

The electrical component(s) may include at least one power converter contained within a barcode reader.

The illustrations included herewith are not meant to be actual views of any particular systems, memory device, architecture, or process, but are merely idealized representations that are employed to describe embodiments herein. Elements and features common between figures may retain the same numerical designation except that, for ease of following the description, for the most part, reference numerals begin with the number of the drawing on which the elements are introduced or most fully described. In addition, the elements illustrated in the figures are schematic in nature, and many details regarding the physical layout and construction of a memory array and/or all steps necessary to access data may not be described as they would be understood by those of ordinary skill in the art.

As used herein, the singular forms “a,” “an,” and “the” are intended to include the plural forms as well, unless the context clearly indicates otherwise.

As used herein, “or” includes any and all combinations of one or more of the associated listed items in both, the conjunctive and disjunctive senses. Any intended descriptions of the “exclusive-or” relationship will be specifically called out.

As used herein, the term “configured” refers to a structural arrangement such as size, shape, material composition, physical construction, logical construction (e.g., programming, operational parameter setting) or other operative arrangement of at least one structure and at least one apparatus facilitating the operation thereof in a defined way (e.g., to carry out a specific function or set of functions).

As used herein, the phrases “coupled to” or “coupled with” refer to structures operably connected with each other, such as connected through a direct connection or through an indirect connection (e.g., via another structure or component).

The foregoing method descriptions and/or any process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be communicated (e.g., passed, forwarded, and/or transmitted) via any suitable means including memory sharing, message passing, token passing, network transmission, etc.

The actual software code or specialized control hardware used to implement these systems and methods is not limiting of the disclosure. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The previous description is of various preferred embodiments for implementing the disclosure, and the scope of the invention should not necessarily be limited by this description. The scope of the present invention is instead defined by the claims.

What is claimed is:

1. A computer-implemented method of notifying a user of a potential or actual fault of at least one electrical component, said method comprising:
sensing input electrical power to the at least one electrical component over a time period;
sensing output electrical power from the at least one electrical component over the time period;
sensing temperature of the at least one electrical component over the time period;
calculating at least one time-based measurement as a function of the sensed input electrical power, output electrical power, and temperature of the at least one electrical component over the time period;
determining, based on the at least one time-based measurement, behavior from amongst multiple possible behaviors that the at least one electrical component is exhibiting over the time period; and
in response to determining the behavior of the at least one electrical component over the time period, generating a notification signal to be presented to the user that notifies the user to perform a prescriptive action to correct the potential or actual fault of the at least one electrical component.

2. The method according to claim 1, wherein calculating at least one time-based measurement includes calculating (i) thermal resistance over the time period and (ii) a derivative of the thermal resistance over the time period of the at least one electrical component.

3. The method according to claim 1, wherein generating a notification signal includes illuminating at least one illumination device indicative of the prescriptive action to be taken.

4. The method according to claim 1,
wherein generating a notification signal includes generating text descriptive of the potential or actual fault to be displayed on an electronic display; and
further comprising communicating the text to be displayed on an electronic device for a user to view.

5. The method according to claim 1, further comprising:
storing data indicative of the multiple possible behaviors that the at least one electrical component exhibits over time, the data indicative of the multiple possible behaviors including data defined by derivative functions of changes in thermal resistance of the at least one electrical component over time; and
wherein determining behavior from amongst multiple possible behaviors includes determining which data indicative of the multiple possible behaviors most closely represents the calculated at least one time-based measurement of the at least one electrical component over the time period.

6. The method according to claim 5, wherein storing data indicative of the multiple possible behaviors includes storing metadata descriptive of data defined by derivative functions of changes in thermal resistance of the at least one electrical component overtime, and further comprising storing a table inclusive of the metadata in independent records, the metadata including at least one of (i) flat, (ii) consecutive positive peaks with low magnitude, (iii) alternating positive and negative peaks with different magnitude, and (iv) rapid positive peak with high magnitude.

7. The method according to claim 5, wherein storing the data indicative of the multiple possible behaviors further includes storing possible diagnoses and prescriptions in association with each of the respective possible behaviors, and wherein generating text includes selecting an associated prescription with the determined behavior.

8. The method according to claim 1, wherein determining behavior from amongst multiple possible behaviors includes determining behavior locally on a device in which at least one electrical component is operating.

9. The method according to claim 1, wherein sensing input electrical power, output electrical power, and temperature from at least one electrical component over time includes sensing input electrical power, output electrical power, and temperature from at least one electrical component over time of a power converter contained within a handheld electronic device.

10. A system comprising:
at least one input power sensor configured to sense input electrical power to at least one electrical component over a time period;
at least one output power sensor configured to sense output electrical power from the at least one electrical component over the time period;
at least one temperature sensor configured to sense temperature of the at least one electrical component over the time period; and
at least one processor configured to receive communications signals from the sensors, the at least one processor configured to:
calculate at least one time-based measurement as a function of the sensed input electrical power, output electrical power, and temperature of the at least one electrical component over the time period;
determine, based on the at least one time-based measurement, behavior from amongst multiple possible behaviors that the at least one electrical component is exhibiting over the time period; and
in response to determining the behavior of the at least one electrical component over the time period, generate a notification signal to be presented to the user that notifies the user to perform a prescriptive action to correct the potential or actual fault of the at least one electrical component.

11. The system according to claim 10, wherein the at least one processor, in calculating at least one time-based measurement, is configured to calculate (i) thermal resistance over the time period and (ii) a derivative of the thermal resistance over the time period of the at least one electrical component.

12. The system according to claim 10, wherein the input power sensor and the output power sensor are configured to monitor respective input and output electrical powers of the system, and the temperature sensor is configured to monitor the temperature of the system as a whole rather than monitoring one or more of the electrical components.

13. The system according to claim 10, wherein the input power sensor and the output power sensor are configured to monitor the input and output electrical power, respectively, and the temperature sensor is configured to monitor the temperature of an individual electrical component.

14. The system according to claim 10, including a plurality of input power sensors, output power sensors, and temperature sensors, that are configured to monitor the input and output electrical power, and the temperatures, of a group of respective individual electrical components.

15. The system according to claim 14, wherein the processor is further configured to:
compare measured input power, output power, and temperatures of respective individual electrical components with one another to determine differences between respective measurements; and
in response to determining that a difference above a threshold level between the measurements of the respective individual electrical components exists, generate a second notification signal to be presented to the user that notifies the user to perform a prescriptive action to correct the potential or actual fault of at least one of the respective individual electrical components.

16. The system according to claim 11, wherein the at least one processor is further configured to:
store data indicative of the multiple possible behaviors that the at least one electrical component exhibits over time, the data indicative of the multiple possible behaviors including data defined by derivative functions of changes in thermal resistance of the at least one electrical component over time; and
determine behavior from amongst multiple possible behaviors by determining which data indicative of the multiple possible behaviors most closely represents the calculated at least one time-based measurement of the at least one electrical component over the time period.

17. The system according to claim 16, wherein the at least one processor, in storing data indicative of the multiple possible behaviors, is configured to store metadata descriptive of the data defined by derivative functions of changes in thermal resistance of the at least one electrical component over time, and further comprising a non-transitory memory in communication with the at least one processor, and configured to store at least one table inclusive of the metadata stored in independent records, the metadata including at least one of (i) flat, (ii) consecutive positive peaks with low magnitude, (iii) alternating positive and negative peaks with different magnitude, and (iv) rapid positive peak with high magnitude.

18. The system according to claim 16, wherein the at least one processor is configured to store possible diagnoses and prescriptions in association with each of the respective possible behaviors, and wherein the at least one processor is further configured to select an associated prescription with the determined behavior when generating text.

19. The system according to claim 11, wherein the at least one processor is locally operating on a device in which at least one electrical component is operating.

20. The system according to claim 11, wherein the at least one electrical component includes at least one power converter contained within a barcode reader.
